(19) United States
(12) Patent Application Publication
(10) Pub. No.: US 2014/0101013 A1
(43) Pub. Date: Apr. 10, 2014

(54) SELF-SERVICE INTERFACE FOR POLICY CONTROL IN THE CLOUD

(71) Applicant: International Business Machines Corporation, Armonk, NY (US)

(72) Inventors: SALMAN A. BASET, New York, NY (US); Fausto Bernardini, New York, NY (US); Rong N. Chang, Pleasantville, NY (US); Chang-Shing Perng, Goldens Bridge, NY (US); Edward C. So, Flushing, NY (US); Chunqiang Tang, Ossining, NY (US); Tao Tao, Briarcliff Manor, NY (US)

(73) Assignee: International Business Machines Corporation, Armonk, NY (US)

(21) Appl. No.: 14/064,978

(22) Filed: Oct. 28, 2013

Related U.S. Application Data
(63) Continuation of application No. 13/647,832, filed on Oct. 9, 2012.

(51) Int. Cl. G06F 17/30; G06Q 40/00

(52) U.S. Cl. CPC G06F 17/30289; G06Q 40/00
USPC 705/35; 707/805

(57) ABSTRACT

One embodiment of a computer readable storage medium contains an executable program for providing a cloud-based service to an enterprise comprising a plurality of members, where the program causes a processor to perform steps including receiving at least a portion of a policy a first user within the enterprise, where the policy defines a limit on usage of the cloud-based service by at least some of the plurality of members, receiving a request for the cloud-based service from a second user associated with one of the plurality of members, and automatically responding to the request in accordance with the policy.

### CROSS REFERENCE TO RELATED APPLICATIONS

This application is a continuation of co-pending U.S. patent application Ser. No. 13/647,832, filed Oct. 9, 2012, which is herein incorporated by reference in its entirety.

### BACKGROUND OF THE INVENTION

The present invention relates generally to cloud computing and relates more specifically to policy control for cloud-based services.

Cloud computing is the use of computing resources (e.g., hardware and software) that are delivered as a service over a network (e.g., the Internet). Self-service (i.e., the ability to secure services without intervention from a human service provider) and auto-scaling (i.e., automatic increase and/or decrease of resource provisioning in response to demand) are seen as two of the major benefits of cloud computing. For instance, an enterprise (e.g., a business or other organization) may move a portion of its information technology (IT) infrastructure to “the cloud” as a means of simplifying maintenance of the IT infrastructure. However, this also results in the enterprise relinquishing some control over the IT infrastructure, since the account structure in a conventional cloud environment does not reflect the type of hierarchical organizational structure typical of most enterprises.

IT budget control and organizational governance are much more difficult to enforce in the cloud, since the structure of the cloud may allow traditional business processes that enforce these concepts to be circumvented. For instance, the typical cloud environment is not structured in a way that allows an enterprise to easily review or control the spending or actions of its various sub-divisions (e.g., lines of business, departments, projects, personnel, etc.) or that allows these sub-divisions to access up-to-date allocations of a changing budget. It is also difficult to prevent, from outside of the cloud, abuse or mistakes that may result in unintentional events and expenditures. As an example, a simple bug in the code of an auto-scaling controller might inadvertently result in the creation of one thousand virtual machines when only one virtual machine is required.

Naïve solutions to these problems include blindly embracing the self-service and auto-scaling benefits of the cloud while sacrificing financial control and organizational governance, or restricting usage of the cloud in a manner that preserves financial control and organizational governance, but fails to fully take advantage of the major benefits of cloud computing.

### SUMMARY OF THE INVENTION

One embodiment of a computer readable storage medium contains an executable program for providing a cloud-based service to an enterprise comprising a plurality of members, where the program causes a processor to perform steps including receiving at least a portion of a policy a first user within the enterprise, where the policy defines a limit on usage of the cloud-based service by at least some of the plurality of members, receiving a request for the cloud-based service from a second user associated with one of the plurality of members, and automatically responding to the request in accordance with the policy.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting one example of a network within which embodiments of the present invention may be deployed;

FIG. 2 is a flow diagram illustrating one embodiment of a method for providing a cloud-based service, according to the present invention;

FIG. 3 illustrates an exemplary set of policies that is defined in a hierarchical or tree-like graph structure; and

FIG. 4 is a high-level block diagram of the policy control method that is implemented using a general purpose computing device.

### DETAILED DESCRIPTION

In one embodiment, the invention is a self-service interface for policy control in the cloud. Embodiments of the invention define an application programming interface (API) and a graphical user interface (GUI) that allows a cloud user to interact with a cloud-based service provider. In particular, the API and GUI are mechanisms that allow the cloud user to define policies for an enterprise that is served by the cloud-based service provider. These policies may include policies that enforce financial control and/or organizational governance within the enterprise. As an example, the cloud user might use the API and GUI to define an arbitrarily complex virtual organization chart and fine-grained budget control policies for any entities in the organization. Any policies specified by the cloud user are enforced by the cloud-based service provider at runtime.

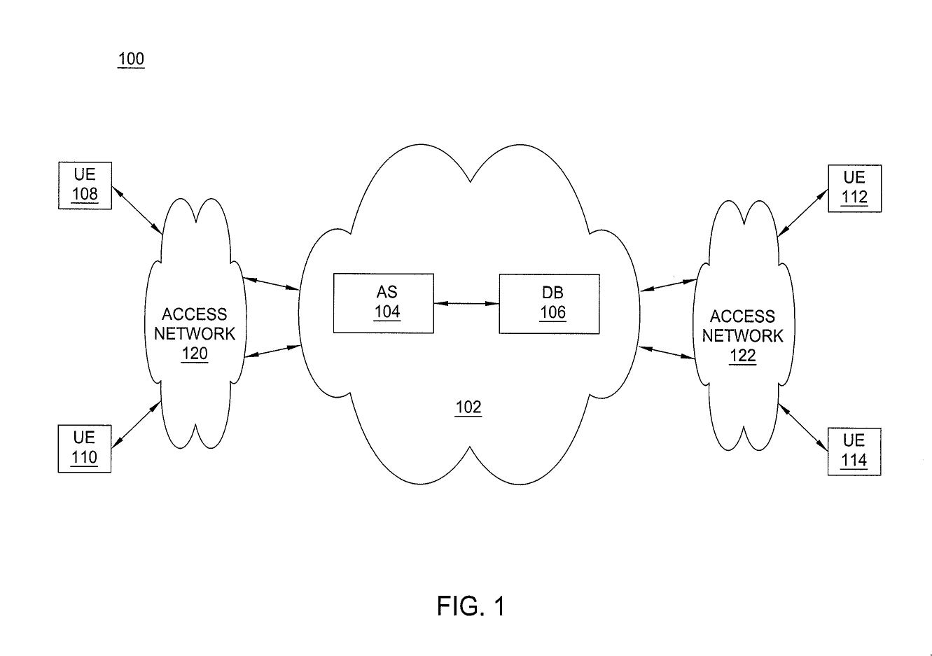

FIG. 1 is a block diagram depicting one example of a network 100 within which embodiments of the present invention may be deployed. The network 100 may be any type of communications network, such as for example, an Internet Protocol (IP) network (e.g., an IP Multimedia Subsystem (IMS) network, an asynchronous transfer mode (ATM) network, a wireless network, a cellular network, a long term evolution (LTE) network, and the like). An “IP network” is broadly defined as a network that uses Internet Protocol to exchange data packets. Additional exemplary IP networks include Voice over IP (VoIP) networks, Service over IP (SoIP) networks, and the like.

In one embodiment, the network 100 may comprise a core network 102. The core network 102 may be in communication with one or more access networks 120 and 122. The access networks 120 and 122 may include a wireless access network (e.g., a WiFi network and the like), a cellular access network, a cable access network, a wired access network and the like. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one embodiment, the core network 102 may include an application server (AS) 104 and a database (DB) 106. Although only a single AS 104 and a single DB 106 are illustrated, it should be noted that any number of application servers 104 or databases 106 may be deployed. For instance, the core network 102 may comprise a portion of a cloud environment in which services and applications are supported in a highly distributed manner.

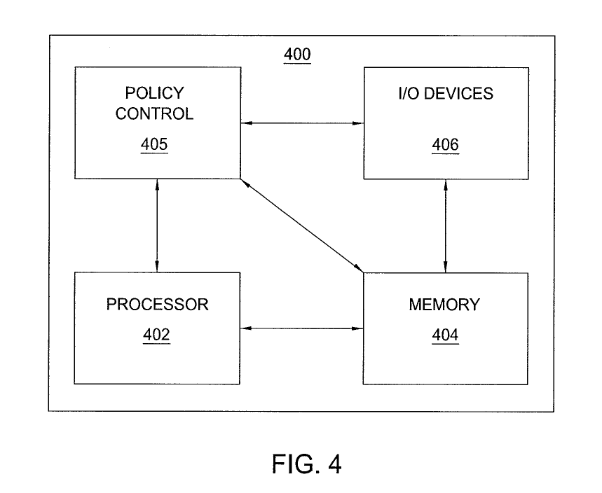

In one embodiment, the AS 104 may comprise a general purpose computer as illustrated in FIG. 4 and discussed below. In one embodiment, the AS 104 may perform the methods and algorithms discussed below related to providing self-service policy control in the cloud. For instance, the AS 104 may comprise a datacenter that supports a cloud-based service (e.g., data provisioning or other IT-related services).

In one embodiment, the DB 106 stores data relating to users of the cloud-based service supported by the AS 104. For instance, the DB 106 may store user-defined virtual organization charts and fine-grained control policies for any entities in the organizations, as well as payment information, user identifications, passwords, and other access or authentication information. This information may be stored in encrypted form in order to protect any information that is deemed to be sensitive.

In one embodiment, the access network 120 may be in communication with one or more user endpoint devices (also referred to as “endpoint devices” or “UE”) 108 and 110. In one embodiment, the access network 122 may be in communication with one or more user endpoint devices 112 and 114.

In one embodiment, the user endpoint devices 108, 110, 112 and 114 may be any type of endpoint device that is capable of accessing services from a cloud-based service provider, such as a desktop computer or a mobile endpoint device such as a cellular telephone, a smart phone, a tablet computer, a laptop computer, a netbook, an ultrabook, a portable media device (e.g., an MP3 player), a gaming console, a portable gaming device, and the like. It should be noted that although only four user endpoint devices are illustrated in FIG. 1, any number of user endpoint devices may be deployed. In one embodiment, any of the user endpoint devices may have one or more sensors integrated therein. These sensors may include, for example, location sensors, environmental sensors, acoustic sensors, position sensors, optical sensors, pressure sensors, proximity sensors, and the like. The AS 104 may subscribe to the outputs of these sensors.

It should be noted that the network 100 has been simplified. For example, the network 100 may include other network elements (not shown) such as border elements, routers, switches, policy servers, security devices, a content distribution network (CDN) and the like.

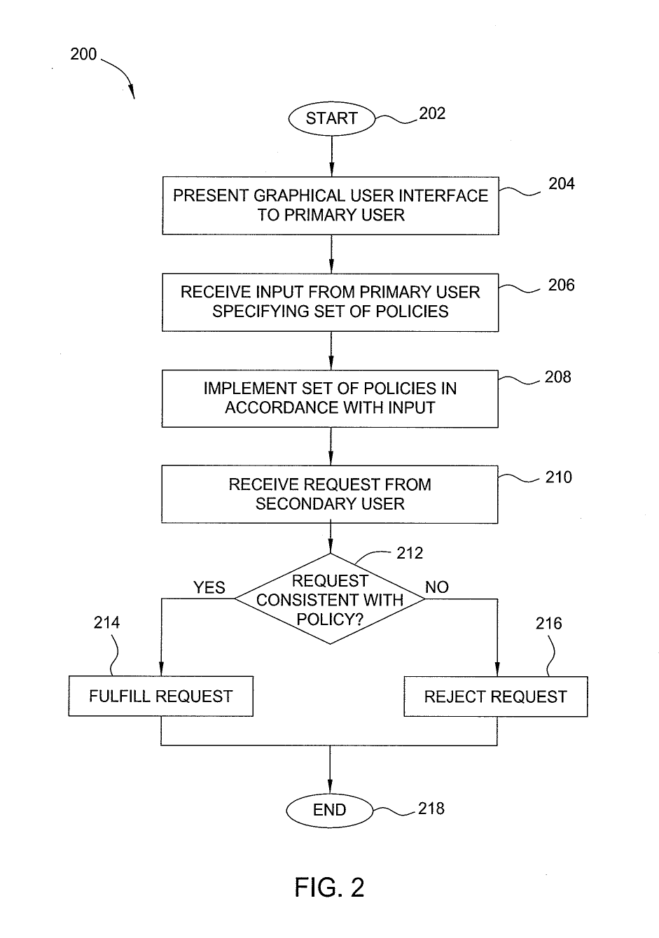

FIG. 2 is a flow diagram illustrating one embodiment of a method 200 for providing a cloud-based service, according to the present invention. The method 200 is described within the exemplary context of providing budget control for IT-related services and infrastructure; however, the method 200 is not so limited and may be used to provide control for other types of policies relating to cloud resource usage. The method 200 may be executed, for example, by the AS 104 illustrated in FIG. 1. As such, reference is made in the discussion of the method 200 to various components of the network 100 illustrated in FIG. 1.

The method 200 begins in step 202. In step 204, a user endpoint device 108-114 presents a GUI to a primary user. The primary user is a user who is authorized to define policies, such as financial, resource usage, or cloud access policies, for an enterprise (e.g., a high-level manager or administrator). The GUI provides an interface that allows the primary user to easily define these policies for enforcement by the AS 104. In one embodiment, the GUI presents a graphical structure (e.g., a hierarchical structure such as a tree, or a directed acyclic graph) that the primary user can manipulate and populate with data to define a set of policies.

In step 206, the AS 104 receives an input from the user endpoint device 108-114 operated by the primary user. The input comprises parameters that collectively specify a set of policies for the enterprise. In one embodiment, the set of policies defines a different policy for each of a plurality of different members or sub-groups within the enterprise. For instance, a set of policies that is meant to enforce budget constraints on the members might define respective budgets for at least some of the members (e.g., a maximum amount of money that a member can spend within a fixed period of time, such as maximum hourly, daily, and/or yearly spending). In one embodiment, the input received from the primary user defines at least one of two parameters: (1) the members and ranks of a virtual organization (e.g., hierarchically defined members of the enterprise); and (2) policies for at least some of the members (e.g., limitations on the members' abilities to consume the cloud-based service).

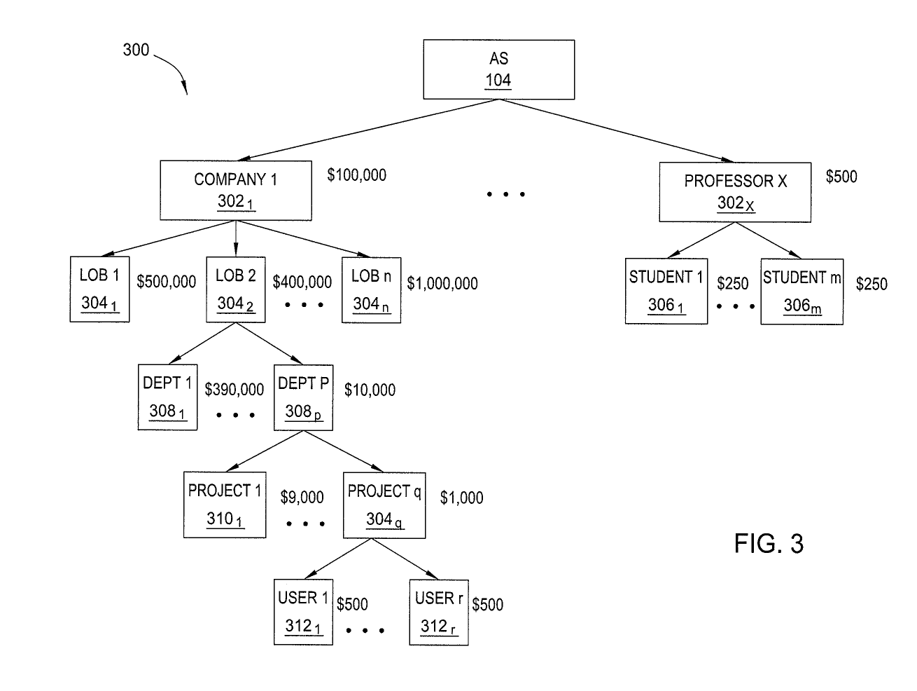

As discussed above, the set of policies may be defined graphically using the GUI. FIG. 3, for example, illustrates an exemplary set of policies that is defined using a hierarchical or tree-like graph structure 300. As illustrated, the AS 104 serves a plurality of enterprises 302₁-302ₓ (hereinafter collectively referred to as “enterprises 302”), including Company 1 and Professor X. Each of these enterprises 302 may include one or more levels of members or sub-groups. For example, the members of Company 1 include a plurality of lines of business (LOBs) 304₁-304ₙ (hereinafter collectively referred to as “LOBs 304”), each of which may in turn include one or more departments 3081-308ₚ (hereinafter collectively referred to as “departments 308”). Each department 308 may, in turn, include one or more projects 310₁-310_{q} (hereinafter collectively referred to as “projects 310”). Each project 310 may include one or more individual human users 312₁-312ᵣ (hereinafter collectively referred to as “users 312”). Professor X may supervise a plurality of students 306₁-306ₘ (hereinafter collectively referred to as “students 306”). Any of these members or sub-groups 304-312 (or any authorized user of the members 302-312) may access the cloud-based service as a secondary user, where a secondary user is authorized to use the cloud-based service subject to the set of policies defined by the primary user and/or another secondary user authorized by a higher-level member of the enterprise 302.

As also discussed above, the graph structure 300 may define, for one or more of the enterprises 302 and associated members 304-312, a respective policy, such as a budget for the enterprise's or member's consumption of the cloud-based service. In the example of FIG. 3, each enterprise 302 and member 304-312 is annotated with a monetary figure (i.e., to the right of each enterprise 302 or member 304-312) that indicates the policy or budget for the enterprise 302 or member 304-312. In one embodiment, this annotation is referred to as a “token” and may define a set of potentially sophisticated control policies for the associated enterprise 302 or member 304-312, as discussed in greater detail below. For instance, the token may define one or more of: the amount of money available to the member 304-312, on what resources the money is permitted to be spent, when the money can be spent, and/or what to do with surpluses (i.e., money that is unspent after expiration of the time period during which spending is authorized).

In one embodiment, the primary user defines policies for only some of the members 304-312, and allows authorized users of the members 304-312 to define the policies of those members that are under their control. For instance, the primary user of Company 1 may define budgets for LOBs 1-n, but allow LOBs 1-n to decide how to divide their budgets among their respective departments. In turn, LOB 2 may define budgets for departments 1 and 2, but allow departments 1 and 2 to decide how to divide their budgets among their respective projects. In sum, the graph structure 300 illustrates how policies (e.g., budget allocations in the illustrated example) trickle down in a given enterprise 302. Although the exemplary graph structure 300 is used to illustrate both the organizational structure and the budget allocations of the illustrated enterprises 302, it will be appreciated that an enterprise's budget flow structure will not always be identical to its organizational structure. For instance, a member 304-312 can receive funding from a parallel sales organization in addition to or instead of from its parent member 304-312. In such a case, the budget flow of the enterprise might be more appropriately depicted as a directed acyclic graph in which the vertices represent the enterprise and the members of the enterprise, and the edges between the vertices represent policies (e.g., budget allocations) that propagate from the enterprise to the members or from one member to another. Thus, in such a case, two separate graph structures for defining the set of policies may be created: (1) a first graph structure (e.g., a tree) that illustrates the organizational structure of the enterprise; and (2) a second graph structure (e.g., a directed acyclic graph) that illustrates the propagation of policies within the enterprise.

Referring back to FIG. 2, once the input from the primary user has been received, the AS 104 implements the set of policies in accordance with the input in step 208. In one embodiment, this includes creating an account or means of access for each member 304-312 that is defined by the primary user, and associating (and saving) the appropriate policy defined by the primary user with each member 304-312. A member's account allows an authorized user of the member 304-312 to access the cloud-based service, subject to the policy defined for the member 304-312.

In step 210, the AS 104 receives a request from a secondary user (i.e., an authorized user of any of the members 304-312). In one embodiment, the request is one that consumes resources of the cloud-based service. For instance, the request may be a request from LOB 1 of Company 1 requesting the provisioning of a new virtual machine. Alternatively, the request may simply comprise input for further defining the set of policies, if the primary user has allowed such input from the members 304-312. For example, an authorized user of LOB 2 may provide input (via the account for LOB 2) as to how to divide LOB 2's budget among its departments 1-p, or the input may add a new department to the set of departments 308.

In step 212, the AS 104 determines whether the request from the secondary user is consistent with the policy defined for the member associated with the secondary user. For instance, referring to the example above, if the provisioning of the new virtual machine would cause the member's budget to be exceeded, then the request would not be consistent with the policy defined for the member.

If the AS 104 concludes in step 212 that the request is consistent with the policy defined for the member, then the AS 104 fulfills the request in step 214. In one embodiment, fulfillment of the request is recorded against the policy defined for the member. For instance, if the policy is a budget and fulfilling the request requires a debit to the budget, then this debit is recorded against the member's budget (i.e., the AS 104 keeps track of how much of the total budget has been consumed). If the request is a further definition of a policy (e.g., addition of a new department or allocation of a budget), then the policy is updated so that the further definition is saved.

Alternatively, if the AS 104 concludes in step 212 that the request is not consistent with the policy defined for the member, then the AS 104 rejects the request in step 216. In one embodiment, rejecting a request includes sending a notification to the secondary user (e.g., to an endpoint device operated by the secondary user) specifying the reason(s) for rejecting the request. For instance, if the request would have caused the member 304-312 to exceed its budget, the notification might inform the secondary user of this fact.

One the request has been fulfilled or rejected as appropriate (i.e., in accordance with either step 214 or step 216), the method 200 ends in step 218.

The method 200 therefore allows authorized users within various levels of an enterprise to perform self-service policy control for their respective levels, without requiring involvement of higher-level representatives or the cloud-based service provider. The policies are enforced by the cloud-based service provider at all levels at run time. Moreover, the policies can be revised at any time by an authorized user (e.g., the primary user or an authorized secondary user) and promptly enforced by the cloud-based service provider.

Although the policies are described above within the exemplary context of budgets, it will be appreciated that the policies defined for any member of an enterprise may specify more than just the member's spending limits or financial restrictions. For instance, in further embodiments, a policy defined in accordance with the method 200 might specify events that should cause alerts to be sent to an administrator or an authorized user of a particular member. In one embodiments, these alerts are triggered by at least one of the following events: changes in resources used by the member (e.g., increase or decrease in number of virtual machines), changes in the usage of resources by the member (e.g., network usage in excess of a defined limit), or a scheduled periodic check (e.g., check every x hours). For instance, a policy for a given member might specify that an alert should be sent to the primary user and/or authorized secondary user when a certain percentage of the member's total budget is spent, or when a certain percentage of the budget is spent on a particular item (e.g., data as opposed to virtual machines). The alert may vary in detail and in one embodiment specifies at least one of the following items: the amount of the member's budget that has already been spent or that is still available, the member's service request history (e.g., provisioning, de-provisioning, size changes), the resources currently in use by the member (e.g., virtual machines, reserved storage), the member's metered usage data (e.g., bytes transferred, number of database transactions, number of block storage accesses), the member's historical spending rates (e.g., hourly, daily, weekly, monthly), or the member's sustainable spending rate (e.g., maximum spending rate that can be maintained until the end of the spending period).

Further embodiments of the invention can take other corrective actions in addition to or in place of alerts. For example, a resource request can be automatically disabled if it would increase spending, resources currently in use may be scaled, or all operation and non-managerial communication related to the member can be suspended at least temporarily.

Where the policies relate to finances or spending, the root account of the enterprise (e.g., Company 1 in FIG. 3) may be backed by a line of credit (e.g., a credit card, cash, or contract). The accounts of the members under the root account may or may not also be backed by a line of credit, depending on how closely they are controlled by the respective ancestor accounts (i.e., the related accounts residing above the member in the hierarchy). For instance, as discussed above, a system of tokens could be used, in which a “root” token for the enterprise is backed by a line of credit and divided among at least some of the members of the enterprise. The tokens function as hard spending limits for the associated members. Furthermore, members can combine multiple tokens (e.g., allocated from multiple funding sources) or transfer tokens to other members.

Division, combination, and transfer of tokens may be subject to certain restrictions, which can also be specified in the policies for the enterprise or a given member of the enterprise. In one embodiment, all control policies associated with a token are propagated to any divisions (i.e., divided portions) of the token. For instance, in this case, none of the divisions can be used to purchase resources that could not be purchased using the original token. Moreover, in this case, the spending time limit associated with the original token is the spending time limit for each division. The cumulative value of the divisions cannot exceed the value of the original token.

In one embodiment, when multiple individual tokens are merged into a combined fund, the control policies for the combined fund are set to the control policies that are common to all of the individual tokens. For instance, in this case, the combined fun can only be used to purchase resources that all of the individual tokens are permitted to purchase individually. Moreover, in this case, earliest spending time limit defined by the individual tokens is the spending time limit for the combined fund. The cumulative value of the combined fund cannot exceed the sum of the values of the individual tokens.

In one embodiment, an authorized user can define a credit issuing function for the cloud-based service provider such that the cloud-based service provider automatically issues tokens to the enterprise's members in accordance with the enterprise's policies. The credit issuing function may define, for example, how often a token is to be allocated to a member, the value of the token, and what is to be done with any surplus. Each member may be assigned a different credit issuing function.

Thus, embodiments of the invention are useful in a variety of situations in which some form of policy enforcement (e.g., budget allocation) is required within a cloud computing environment. For example, a college professor may create an account with a cloud-based service provider as a proxy for a physical laboratory. An account may be created for each of the professor's students, and each account may be associated with a policy that limits the student's spending on cloud resources. In this way, the professor can control the budget for the class. For instance, a single student could not inadvertently consume a disproportionate amount of the budget.

As another example, a large corporation may continually adjust its IT budget allocation and organizational structure over the course of a year. This would normally make it difficult for frontline engineers to balance spending. For instance, the IT budget for an engineering team could be cut, but the team may have no way to access a real-time view of their current budget situation and expenditures by team members, and so might not be aware of the cut in a timely manner. However, using the invention described herein, new budget constraints are enforced automatically. For example, if a manager reduced a budget for a given department via the GUI described above, and a member of the department subsequently submitted a request to the cloud-based service provider that would exceed the new budget for the department, the request would be automatically rejected.

As yet another example, a bug in an auto-scaling controller on the cloud-based service provider side might inadvertently create more virtual machines then is necessary to respond to an unexpected workload (e.g., a misplaced decimal point could result in 1000 virtual machines being created when only one is needed). This mistake, although unintended, could consume an enterprise's entire yearly IT budget in a single hour. However, if the enterprise's account specified a policy by which the hourly spending was limited to a fixed percentage of the yearly IT budget, then the mistaken request would be automatically rejected before any damage could be done.

As discussed above, embodiments of the invention are also useful in a variety of situations in which some form of organizational governance is required within a cloud computing environment. For instance, an employee of an enterprise can create a user identification in the cloud without linking the user identification to a specific enterprise or member account. In this case, the user would not be able to request resources on behalf of any enterprise or member. Alternatively, the user could create and become administrator of a new account, and then associate other users with the account so that the other users may perform actions on behalf of the account. In order to provision resources, the new account must be back by a line or credit or a token as discussed above.

In addition, the administrator of an account can create and link a child account without assistance from other accounts or users. For instance, the administrator of an account associated with LOB 2 of FIG. 3 could create and link an account for department 1 of FIG. 3. The administrator can further associate users with the child account. This creation of child accounts can be performed recursively to construct a complex organizational chart. Eliminating a central managing authority that oversees every change to the chart allows the chart to be easily scaled.

In one embodiment, ancestor accounts have authority over descendant accounts (i.e., accounts that are located in higher levels of the hierarchical organizational structure have authority over linked accounts located in lower levels). Thus the administrator of an ancestor account can suspend a descendant account or de-provision a virtual machine associated with the descendant account. This allows the administrator of the ancestor account to produce reports (e.g., on resource consumption, budget, etc.) at any level below and including the ancestor account. However, depending on the policies (e.g., government regulations), administrators of ancestor accounts may or may not be able to access data stored on a descendant account's virtual machines.

The present invention also allows for easy migration of accounts. For instance, as an enterprise's organizational structure evolves over time, these changes should be represented in the cloud-based depiction. For instance, a change in upper management may result in a given department being managed by a new LOB. In this case, the account associated with the given department should be updated to reflect the connection to the parent account associated with the new LOB. The administrator of the account associated with the old LOB may request this change, which may be subsequently approved by the administrator of the account associated with the new LOB. In addition, the present invention allows ownership of resources to be easily transferred between accounts in a similar manner.

As a specific example of how the present invention may be deployed in an organizational governance scenario, an employee of a company may provision a public-facing virtual machine in the cloud using the company's domain name and subsequently expose inappropriate content on the World Wide Web. Normally, it might take some time before the virtual machine is shut down (e.g., the inappropriate content might not be immediately detected or reported, the decision to shut the virtual machine might not be immediately made or conveyed to the person responsible for shutting down the virtual machine, etc.). However, using the interface described above, the owner of an account that is an ancestor of the account from which the virtual machine originated can set a policy whereby the ancestor account can access and disable the descendant account (and therefore undo or override any actions taken by the descendant account).

Embodiments of the present invention may also be implemented advantageously in the reseller business model. For instance, some cloud computing platforms allow users to pre-purchase cloud computing resources (e.g., virtual machine hours) at a discounted price. A reseller can therefore purchase a large quantity of resources from the cloud computing platform, and then resell the resources to subordinate resellers and/or end users. Using the policy control interface described above, a complex reseller hierarchy can be constructed in which a reseller has total control over its interactions with subordinate resellers and end users.

FIG. 4 is a high-level block diagram of the policy control method that is implemented using a general purpose computing device 400. The general purpose computing device 400 may comprise, for example, the application server 104 illustrated in FIG. 1. In one embodiment, a general purpose computing device 400 comprises a processor 402, a memory 404, a policy control module 405 and various input/output (I/O) devices 406 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the diagnosis module 405 can be implemented as a physical device or subsystem that is coupled to a processor through a communication channel.

Alternatively, the policy control module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the policy control module 405 for self-service policy control in the cloud, as described herein with reference to the preceding figures, can be stored on a tangible computer readable storage medium or device (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A computer readable storage medium containing an executable program for providing a cloud-based service to an enterprise comprising a plurality of members, where the program causes a processor to perform steps comprising:
presenting a first user within the enterprise with a graphical user interface, wherein the graphical user interface displays a graphical data structure comprising a plurality of elements and a plurality of relationships between the plurality of elements;
receiving from the first user an alteration to the graphical data structure, wherein the alteration results in a definition of at least a portion of a policy, where the policy defines a limit on usage of the cloud-based service by at least some of the plurality of members;
receiving a request relating to usage of the cloud-based service from a second user associated with one of the plurality of members;
automatically fulfilling the request when the request is consistent with the policy; and
automatically rejecting the request when the request is inconsistent with the policy, by sending a notification to the second user specifying a reason for the rejecting.

2. The computer readable storage medium of claim 1, wherein the automatically fulfilling and the automatically rejecting are performed without consulting another of the plurality of members that is located in a higher level of the hierarchy than the one of the plurality of members.

3. The computer readable storage medium of claim 1, wherein the steps further comprise:
receiving a change to the policy from the first user; and
modifying the policy in accordance with the change to produce an updated policy, wherein a request received from the at least some of the plurality of members subsequent to the modifying is automatically fulfilled or rejected in accordance with the updated policy.

4. The computer readable storage medium of claim 1, wherein the policy specifies a financial budget for usage of the cloud-based service by the at least some of the plurality of members.

5. The computer readable storage medium of claim 4, wherein the request comprises a request to divide a portion of the financial budget allocated to the one of the plurality of members among others of the plurality of members that are supervised by the one of the plurality of members.

6. The computer readable storage medium of claim 4, wherein the financial budget is backed by the enterprise with a line of credit.

7. The computer readable storage medium of claim 6, wherein a portion of the financial budget allocated to the one of the plurality of members is backed with a virtual form of payment that is associated with a set of control policies.

8. The computer readable storage medium of claim 7, wherein the set of control policies defines at least one of: a spending limit for the one of the plurality of members, a limit on a type of goods or services that the one of the plurality of members may purchase with the portion of the financial budget, or a time limit within which the one of the plurality of members must use the portion of the financial budget.

9. The computer readable storage medium of claim 1, wherein the first user is authorized to override the second user.

10. The computer readable storage medium of claim 1, wherein the request comprises a request for a resource from the cloud-based service.

11. The computer readable storage medium of claim 10, wherein the resource is an information technology resource.

12. The computer readable storage medium of claim 1, wherein the request comprises a request to further define the policy for another of the plurality of members that is supervised by the one of the plurality of members.

13. The computer readable storage medium of claim 1, wherein the request comprises a request to create a new one of the plurality of members that is supervised by the one of the plurality of members.

14. The computer readable storage medium of claim 1, wherein the alteration comprises a value that populates one of the plurality of elements.

15. The computer readable storage medium of claim 1, wherein the alteration comprises a change in an arrangement of the plurality of elements, wherein the alteration comprises at least one of: an addition of a new element to the plurality of elements, a deletion of an element from the plurality of elements, or a change in the plurality of relationships.

16. The computer readable storage medium of claim 1, wherein the rejecting further comprises:
scaling a resource of the cloud-based service that is currently in use, in response to the request.

17. The computer readable storage medium of claim 1, wherein the rejecting further comprises:
suspending at least some communication capability of the second user, in response to the request.

18. The computer readable storage medium of claim 1, wherein fulfilling the request comprises:
recording a fulfillment of the request against the policy.

19. A system for providing a cloud-based service to an enterprise comprising a plurality of members, the system comprising:
a processor; and
a computer readable storage medium containing an executable program that causes the processor to perform steps comprising:
presenting a first user within the enterprise with a graphical user interface, wherein the graphical user interface displays a graphical data structure comprising a plurality of elements and a plurality of relationships between the plurality of elements;
receiving from the first user an alteration to the graphical data structure, wherein the alteration results in a definition of at least a portion of a policy, where the policy defines a limit on usage of the cloud-based service by at least some of the plurality of members;
receiving a request relating to usage of the cloud-based service from a second user associated with one of the plurality of members;
automatically fulfilling the request when the request is consistent with the policy; and
automatically rejecting the request when the request is inconsistent with the policy, by sending a notification to the second user specifying a reason for the rejecting.

20. The system of claim 19, wherein the steps further comprise:
receiving a change to the policy from the first user; and
modifying the policy in accordance with the change to produce an updated policy, wherein a request received from the at least some of the plurality of members subsequent to the modifying is automatically fulfilled or rejected in accordance with the updated policy.
